(19) United States
(12) Patent Application Publication
(10) Pub. No.: US 2024/0324490 A1
(43) Pub. Date: Oct. 3, 2024

(54) ROW CROP PLANTING METHODS AND SYSTEMS

(71) Applicant: AG USA LLC, Muncie, IN (US)

(72) Inventor: William Michael FRASIER, Muncie, IN (US)

(21) Appl. No.: 18/128,522

(22) Filed: Mar. 30, 2023

(51) Int. Cl. A01C 7/04; A01C 7/10

(52) U.S. Cl. CPC A01C 7/04; A01C 7/102

(57) ABSTRACT

Seeding and planting methods and techniques for row crops, especially soybeans, are described herein as are hardware configurations for practicing such methods and techniques. According to the methods and techniques disclosed, soybean seeding rates and plant populations higher than those previously practiced result in higher yields using less water, less fuel, and fewer applications of herbicides.

### FIELD

The claimed technology relates generally to methods and systems of planting row crops and more particularly to methods and systems of planting soybeans and small grains such as wheat, oats, and the like.

### BACKGROUND

Traditionally row crops such as soybeans have been planted either using a row crop planting machine or a seed drill. The exact method of handling and placing seeds differs between row planters and seed drills, but at a broad level both methods involve opening a furrow in the soil, depositing seeds, then closing the soil over the seeded furrow to form rows of plants once the seeds germinate. The width between rows for soybeans are typically between 7.5 inches (when drilled) and 38 inches (when row crop planted) depending on soil type, climate, seed variety, and potentially other factors. Under most conditions, it is recommended that row spacing for soybeans is between 7.5 inches and 15 inches to maximize yield.

To calculate the seeding rate (i.e., the number of seeds planted per unit of area) the following formula may be used:

$$\frac{Desired Plant Population}{( Germination \% ) \times ( Pure Seed \% ) \times ( Live Seed Emergence \% )} = Seeding Rate$$

Other factors such as post-emergent losses such as disease, pests, weather, and the like may also be included in such calculations. Seed companies, university agricultural departments, and local extension offices set recommendations for plant population rates intended to maximize yields and/or reduce input costs. For soybeans, recommended plant populations are typically between 104,000 plants per acre and 174,000 plants per acre achieved using a seeding rate between 130,000 seeds per acre and 217,000 seeds per acre depending on row spacing and soil conditions. Such seeding rates are widely believed to maximize yield for a given area while reducing costs relating to purchasing seed. According to the methods and systems of the present disclosure, however, these recommended seeding rates are overly conservative and higher yields can be achieved without increasing (and often by decreasing) overall input costs relating to irrigation, fuel, and herbicides.

### BRIEF DESCRIPTION OF THE DRAWINGS

FIG. 1 is a top plan view of plants seeded in rows.

FIG. 2 is a top plan view of inter row seeding of plants.

FIG. 3 is a top plan view of seeding according to one embodiment.

FIG. 4 is a side view of a seeding unit from a row crop planter.

FIG. 5 is a top diagrammatic view of a planter according to one embodiment.

FIG. 6 is a top diagrammatic view of a planter according to another embodiment.

FIG. 7 is a top diagrammatic view of a planter according to yet another embodiment.

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

The methods and systems are described herein using soybeans as an example for illustrative purposes only. The disclosed methods and systems may also be applied to beneficial effect using other row crops including rye, wheat, barley, sorghum, oats, and the like. Soybeans are traditionally planted using a seeding rate of between 130,000 seeds per acre and 217,000 seeds per acre depending on row spacing and soil conditions. Row spacing can vary anywhere from about 7 inches if seeded using a grain drill to about 30 inches using a row crop planter. According to the methods and systems of the present disclosure such row widths are too wide and such seeding rates are much too low to achieve optimal crop yields and/or return on investment per acre planted.

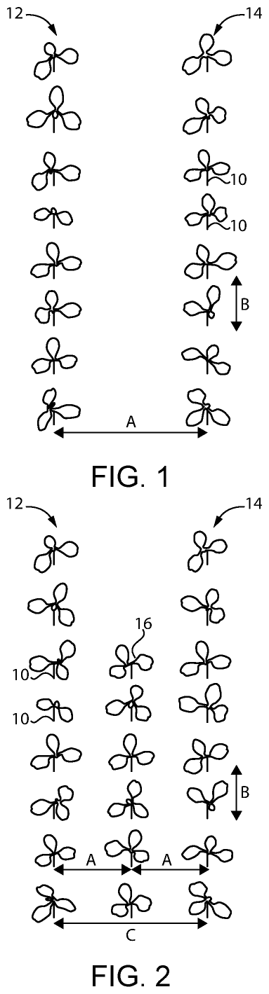

As seen in FIGS. 1-2 a first row of soybean plants 12 is planted a distance A away from a second row of soybean plants 14. Individual plants in a particular row are spaced at a distance B from one another. Traditionally soybeans are planted using seed drills in rows that are 4 to 10 inches apart and with row crop planters in rows that are 15 to 38 inches apart with the distance between individual plants in a particular row varying according to the desired plant population. For example, using traditional planting densities individual plants in a particular row are from 4.8 inches (7.5 inch drilled rows) to 2.4 inches (15 inch row crop planted rows) to 1.2 inches (30 inch row crop planted rows) apart from one another if the desired plant population is 174,000 plants per acre. Using traditional planting densities individual plants in a particular row are from 8 inches (7.5 inch drilled rows) to 4 inches (15 inch row crop planted rows) to 2 inches (30 inch row crop planted rows) apart from one another if the desired plant population is 104,000 plants per acre.

According to one embodiment of the disclosed invention the first row 12 and second row 14 are spaced less than 10 inches apart (distance A). In another embodiment the first row 12 and second row 14 are spaced less than 7 inches apart. In still other embodiments first row 12 and second row 14 are spaced between 3 inches and 7 inches apart (distance A) with the distance between individual plants in a particular row varying according to the desired plant population (distance B). For example, for a desired plant population of 240,000 plants per acre individual plants in a particular row would be approximately 8.6 inches apart (3 inch rows), 5.2 inches apart (5 inch rows), and 3.7 inches apart (7 inch rows). For a desired plant density of 280,000 plants per acre individual plants in a particular row would be approximately 7.5 inches apart (3 inch rows), 4.5 inches apart (5 inch rows), and 3.2 inches apart (7 inch rows). Such narrow row spacings and high plant densities per row require a sufficient planting rate to result in a live plant population of 240,000 to 280,000 plants per acre in one embodiment. In other embodiments, higher plant populations of 300,000 or more may be used. The disclosed methods may be used to produce plant populations of up to 280,000 plants per acre in first crops/full season plantings and populations of up to 600,000 plants per acre in second crop/short season plantings. The exact seeding rate required to achieve such high plant populations varies according to the germination percentage of the seeds, the percentage of pure seed used, and the live seed emergence rate as well as potentially other factors as noted above.

In one embodiment, rows 12, 14 are planted at the desired spacing and seed density in a single operation, such as a single pass of a mechanical planter (FIG. 1). Such a single pass operation requires planting machines which are described in greater detail below. In another embodiment, the rows 12, 14 are planted at approximately twice the desired distance from one another (distance C) in a first operation and then a third row 16 is planted between first row 12 and second row 14 in a second operation such that third row 16 is at the desired distance A from first row 12 and second row 14.

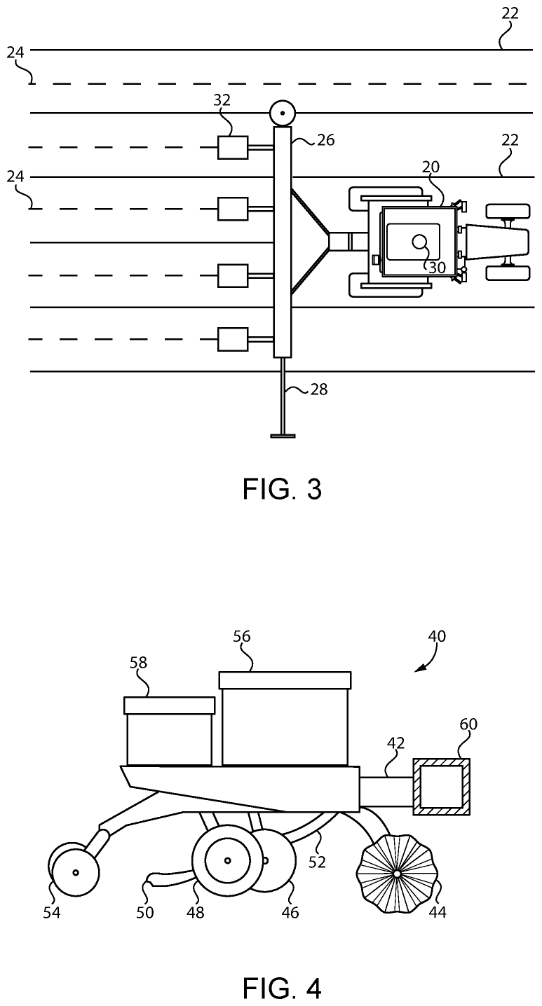

One example of a two-operation planting technique is shown in FIG. 3. In this example, a first set rows 22 are planted using a row crop planter 26 pulled by a tractor 20 as part of a first operation. The second operation includes passing over the already planted soil with the row planter 26 a second time such that the second operation plants a second set of rows 24 which are disposed between the rows of the first set of rows 22. In such a two-operation method it is important that the row planter 26 be aligned such that the seeding assemblies 32 are aligned so as to not to track over and disturb the already planted first rows 22. Proper alignment may be achieved using a variety of techniques such as using row marker devices 28 equipped on the planter 26 or by using GPS or other locating devices 30 mounted on the tractor 20 and/or on the planter 26. Such a two-operation planting technique would allow a farmer to practice the seeding and planting methods described herein using existing planters with minimal modifications to such machines to achieve the seeding rates and plant populations described herein.

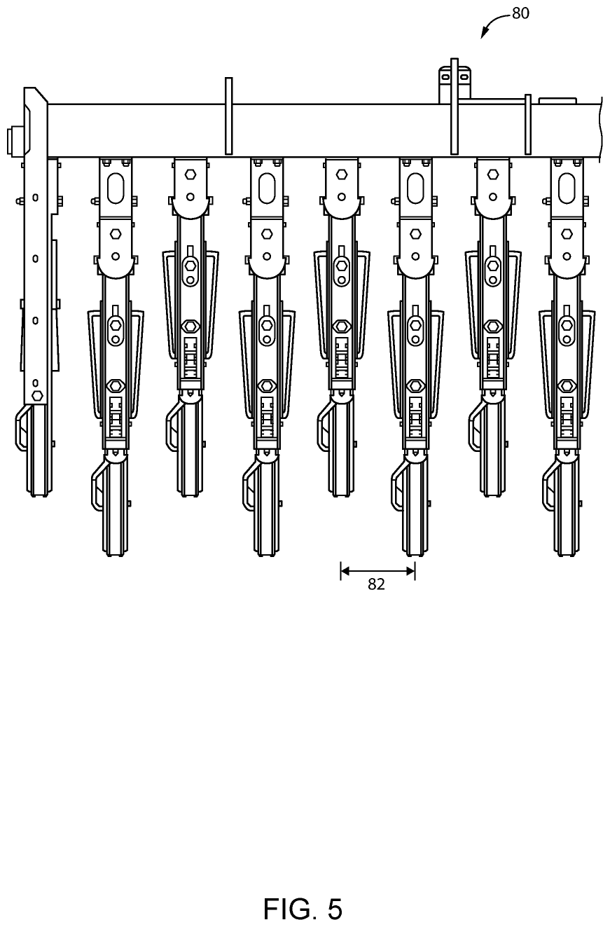

Traditionally such crops are seeded using a row crop planter comprising one or more seeding assemblies 40 or gangs (such as shown in FIG. 4) attached to a toolbar or using a seed drill (such as shown in FIG. 5). Row crop planters have a variety of advantages over seed drills. Typically row crop planters are more accurate in metering and delivering individual seeds at a desired rate than a drill. More precise seed delivery yields lower overall costs as less seed is required to achieve the desired plant density. Row crop planters typically include one or more seeding assemblies 40 which include a plurality of components mounted to a toolbar 42 which is mounted to a draw bar 60. Each toolbar 42 is spaced at a distance from other toolbars on the draw bar 60. Typically the toolbars are spaced so as to produce crop rows which are 30 inches apart, but many planters allow for this spacing to be adjusted so as to produce crop rows which are anywhere from 12 inches to 40 inches apart. Each assembly 40 may include a variety of components but typically include at least one trash wheel or coulter 44 for cutting through/clearing debris on or just below the soil surface, one or more opening discs 46 for creating a furrow, one or more gauge wheels 48 for controlling the depth of the furrow, a seed tube 52 which deposits seeds in the furrow, a firmer device 50 which presses the seed into the bottom of the furrow to insure seed contact with the soil and speed germination, one or more closing wheels for moving soil to close the furrow. Each assembly 40 may further include one or more container boxes 56, 58 which may store seed or dry amendments such as fertilizer, pesticides, fungicides, and the like. In such configurations, seed or amendments may be delivered to the planting furrow from the storage boxes using gravity. In other examples, seed and dry amendments are contained in one or more larger, storage hoppers or containers which may be disposed elsewhere on the planter or towed on a separate device. In such configurations the seed and dry amendments are transported to each toolbar 40 using one or more hoses or tubes, typically using pneumatic pressure. Other components may also be attached to a toolbar such as row cleaning wheels which further assist in clearing debris from the soil especially in no-till planting configurations, one or more fluid tubes which typically follow the seed tube and allow for the addition of liquid amendments to the furrow such as pesticides, fertilizers, fungicides, and the like.

The rate at which seed is deposited in a furrow by a row crop planter may be controlled by a notched disc disposed in an individual seed box on a toolbar or one or more seed meters disposed on a larger seed hopper which provides seed to multiple seeding assemblies. Typically such seed dispensing methods are configured to provide seed at the rate of 80,000 to 180,000 seeds per acre. In examples of the disclosed methods, seeding rates of at least 225,000 seeds per acre or more are used. One method to achieve such increased seeding rates is to alter the seed metering system of the planter so as to allow for faster selection and transfer of seeds through the seeding system of the planter to produce a seeding pattern with seeds planted closer together. For example, in seed metering systems which use notched discs to control the rate of seeding discs having more notches spaced closer together may be used in increase the seeding rate. In another example, multiple seed tubes and/or seed metering devices may be used on each seeding assembly. For example, two seed tubes rather than one may be operationally connected to a seed box with each seed tube having its own seed metering device attached thereto. The individual seed metering devices may have slightly offset timing so that they send seeds down their respective seeding tubes in an alternating pattern. Such a configuration is capable of placing twice as many seeds as a single metering system set at the same rate of seed selection. In another example, a single seed metering system is operationally connected to two seed tubes and is capable of selectively depositing seeds in an alternating pattern between the two seed tubes. In still another examples, two or more seed boxes are mounted to or otherwise associated with a single seeder assembly. In such an example, each seed box is operationally connected to a seed metering device or system which is capable of selecting and delivering a seed from the seed box to either an individual seed tube associated with the seed meter or to a shared seed tube. The individual seed metering devices may be coordinated or otherwise have their timings adjusted so that they deposit seeds in a furrow in an alternating pattern. Such a configuration would allow for twice the normal seeding rate for a particular seeding assembly while each seed meter was operating at the standard rate.

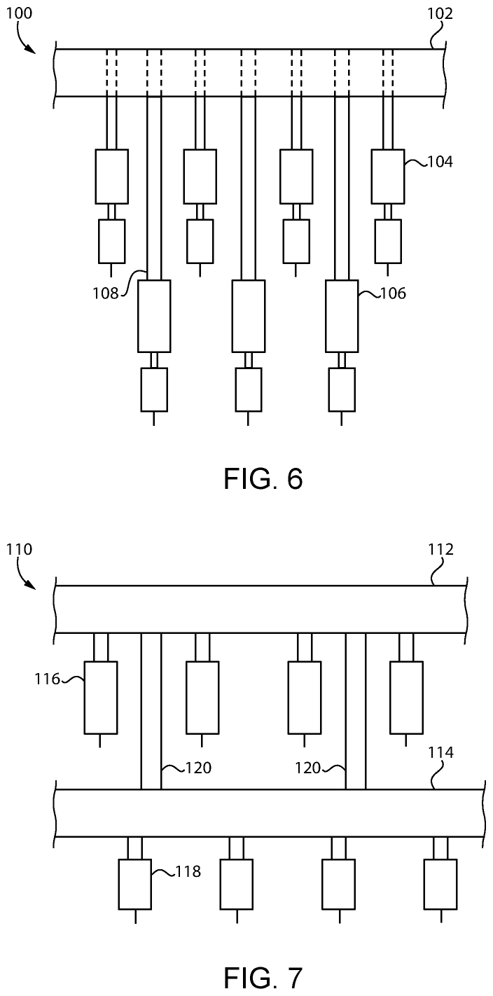

Other methods for increasing the seeding rate of a row planter include adding more seeding assemblies to a particular planter. One example allows for the seeding assemblies to be moved closer together by removing seed boxes from the seeding assemblies and moving them to the draw bar and/or having multiple seeding assemblies draw seeds from a single common seed box. In examples with a single seed box supplying seeds to two or more seeding assemblies each seeding assembly may have its own seed metering system or device associated with it. In other examples, a common or centralized seed metering system or device may supply seeds to multiple seeding assemblies. In another example, individual seeding assemblies are set at different distances from the draw bar. In traditional planters, each seeding assembly is attached directly to a draw bar and each is set back the same distance from that draw bar. In one example of a row planter 100 modified to better practice the planting methods disclosed herein every other seeding assembly 104, 106 is set back at a different distance from the draw bar 102 as seen in FIG. 6. The seeding assemblies 104 proximal to the draw bar 102 use a conventional attachment means and are mounted at a traditional distance from the draw bar 102. The distal or trailing seeding assemblies 106 employ a modified mounting bracket 108 allowing them to be mounted to the draw bar 102 at a greater distance. Such a configuration allows the seeding assemblies to be mounted closer together and to produce rows with a narrower spacing than a traditional row planter while preventing the seeding assemblies from interfering with one another. In another example seen in FIG. 7, a row planter 110 has a primary or forward draw bar 112 and a secondary or rear draw bar 114. The forward draw bar 112 and rear draw bar 114 are operationally connected by one or more cross members 120 allowing for a single tractor to pull the planter 110. Seeding assemblies 116 are mounted to the forward draw bar 112 and other seeding assemblies 118 are mounted to the rear draw bar 114 in an offset pattern such that the two sets of seeding assemblies 116, 118 are able to produce narrower rows than a traditional row planter without the rear seeding assemblies 118 tracking over or otherwise disturbing the rows of the forward seeding assemblies 116. It is understood that still further examples of modified row planters suitable for practicing the disclosed planting methods may employ two or more of the disclosed modifications to produce the high seeding rates required. For example, a row planter similar to that shown in FIG. 6 may also be equipped with two seed tubes and two seed metering devices on each seeding assembly.

As commercially available row crop planters are incapable of producing seeded rows narrower than about 10 inches, a multiple operation method as previously described may be used with a commercially available planter. That is, after a first pass is made with a row crop planter to produce a first set of seeded rows, a second or possibly third pass is performed such that the later seeded rows are disposed between the first seeded rows such as shown in FIG. 2. In another example, two row crop planters, one disposed behind and offset to the first, may be used to produce the narrower rows and higher seeding rates of the disclosed methods. In still another example, a row crop planter having seeding assemblies disposed such that they produced seeded rows 7 inches or less apart may also be used. Such a planter may be purpose built or an existing row crop planter may be modified so as to move the toolbars close enough together so as to produce the desired seed row spacing.

Row crop planters typically produce better results with respect to germination, seed distribution, and the like than seed drills, but seed drills 80 may also be used to practice the methods and techniques disclosed herein. Typical seed drill row spacing 82 is anywhere from 7.5 inches to 10 inches, but most drills are incapable of providing and depositing seed at sufficiently high rates and/or produce inconsistent seed spacing and/or distribution while planting to achieve the seeding populations of the methods and techniques described herein. That is, when a drill is used to try and plant seeds at the high rates described herein the seeds are frequently deposited with uneven spacing (e.g., a group of seeds piled onto or right next to each other followed by a gap with no seeds) which produces uneven results, poor germination, poor survival and/or poor development after sprouting. In examples of the disclosed methods, seeding rates of at least 250,000 or more are used. One method to achieve such increased seeding rates in a seed drill is to incorporate a metering system into the drill similar to those used in conventional row planters (e.g., a metering disc). In another example, a drill having a wider disc spacing (10″) could be used to drill in a first set of planted rows, then using GPS or similar means a second set of planted rows could be drilled between the first set of planted rows similar to the methods described with respect to FIGS. 2-3. Such a method, however, risks disturbing the seeds in the first planted rows while planting the second rows which may result in diminished yields caused by poor germination, altered distribution, and/or accidental destruction of the disturbed seeds of the first planted rows. In another example, a seed drill may be modified so as to have a narrower disc spacing, that is, a disc spacing less than 7.5 inches. Such a drill could also include an improved seed metering system as previously described.

The planting methods and techniques disclosed herein typically produce higher yields using lower inputs of fuel, time, herbicides, and water than existing planting techniques. Seeding at the higher rates disclosed herein results in greater plant density in the field. Increased plant density reduces the amount of water typically required as the higher plant density produces a denser leaf canopy which shields the soil from direct sunlight and reduces evaporation. Reduced water requirements make plants seeded according to these techniques more resistant to drought and/or require less irrigation. The denser leaf canopy also reduces the likelihood of weeds germinating and/or growing between the rows. The weed control produced as a result of the disclosed planting methods may result in an elimination of the need for the application of a post-emergent herbicide typically required when using traditional and/or no-till planting methods. The elimination of the application of a post-emergent herbicide saves money, time, and fuel as well as eliminating damage to the seedlings caused by the machines used to apply the herbicide. The water consumption and weed control benefits of the denser canopy associated with the disclosed planting methods are enhanced by precise seed spacing which helps insure that there are fewer or no gaps in the leaf canopy for direct sunlight to reach the soil surface below the canopy which would encourage weed germination and/or for water vapor to escape through the canopy.

The disclosed planting methods result in higher yields than traditional seeding methods across soil types, climates, and with or without artificial irrigation. Typically, planting soybeans according to the methods disclosed herein will result in yields that are at least 9 bushels per acre higher than conventionally planted soybeans. In one example, unirrigated test plots in a field having high yield environmental factors such as high levels of organic matter planted according to the methods described herein produced on average 20 bushels per acre more than conventionally planted plots. In another example, unirrigated plots in a field having lower yield environmental factors such as a hilly field having soil with high clay levels planted according to the methods described herein yielded on average 12 bushels per acre more than conventionally planted plots. In still other examples the exact scale of increase of yields using the planting methods described herein over conventionally planted beans varied according to soil type, irrigation status, drainage, climate, and other factors. Increases in yield of up to approximately 40% over conventional planting rates and methods were seen in some examples by using the planting methods described herein.

The exact scale of increased yield using the disclosed planting methods and technique will vary according to the seed type used, soil type and conditions, climate, and the like. The timing of seeding may also impact the results of the disclosed methods. For example, second crops planted using the disclosed methods in the same growing season after a first crop (such as wheat or rye) has been harvested typically show a greater increase in yield over traditionally planted second crops than do crops seeded earlier in the year.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A method of seeding a field with a planter to produce planted rows, comprising:
performing a first planting operation seeding a plurality of individual seeded rows defining a first set of rows;
performing a second planting operation seeding a plurality of individual seeded rows defining a second set of rows such that each of the seeded rows of the second set of rows are disposed between the seeded rows of the first set of rows;
wherein each of the individual seeded rows of the first set of rows are less than ten inches from a seeded row of the second set of rows.

2. The method of claim 1, wherein each of the individual seeded rows of the first set of rows are seven inches from a seeded row of the second set of rows.

3. The method of claim 1, wherein each of the individual seeded rows of the first set of rows are five inches from a seeded row of the second set of rows.

4. The method of claim 1, wherein each of the individual seeded rows of the first set of rows are three inches from a seeded row of the second set of rows.

5. The method of claim 1, wherein the first planting operation and the second planting operation are performed using a row crop planter.

6. The method of claim 1, wherein the first planting operation and the second planting operation produce a live plant population of at least 240,000 plants per acre.

7. The method of claim 1, wherein the first planting operation and the second planting operation produce a live plant population of between 240,000 and 280,000 plants per acre.

8. A method of seeding a field to produce planted rows, comprising:
providing a row crop planter having at least two seeding assemblies and a seed metering system capable of providing seed to the at least two seeding assemblies at a desired rate;
performing a planting operation using the row crop planter to produce seeded rows no more than ten inches apart from one another;
wherein the seed metering system is set to provide seed to the at least two seeding assemblies at a rate of at least 240,000 seeds per acre.

9. The method of claim 8, wherein the row crop planter to produce seeded rows no more than seven inches apart from one another.

10. The method of claim 8, wherein the row crop planter to produce seeded rows no more than five inches apart from one another.

11. The method of claim 8, wherein the row crop planter to produce seeded rows no more than three inches apart from one another.

12. The method of claim 8, wherein the seed metering system is set to provide seed to the at least two seeding assemblies at a rate of between 240,000 and 280,000 seeds per acre.

13. The method of claim 8, wherein the seed provided by the metering system to the at least two seeding assemblies is soybean seed.

14. A method of planting soybeans, comprising:
performing a planting operation using a row crop planter seeding at least two rows of soybean seeds at a distance of no more than ten inches apart at a seeding rate of at least 240,000 seeds per acre.

15. The method of claim 14, wherein the at least two rows of soybeans seeds are at a distance of no more than seven inches apart.

16. The method of claim 14, wherein the at least two rows of soybeans seeds are at a distance of no more than five inches apart.

17. The method of claim 14, wherein the at least two rows of soybeans seeds are at a distance of no more than three inches apart.

18. The method of claim 14, wherein the seeding rate is between 240,000 and 280,000 seeds per acre.
